(19) United States
(12) Patent Application Publication
(10) Pub. No.: US 2008/0220237 A1
(43) Pub. Date: Sep. 11, 2008

(54) Three-Dimensional Structure Consisting of Natural Fibers in the Form of Matting, Panels, Hollow Bodies, Molded Parts or the Like

(76) Inventor: Horst Korger, Rohrbach (DE)

Correspondence Address: BACON & THOMAS, PLLC, 625 SLATERS LANE, FOURTH FLOOR, ALEXANDRIA, VA, 22314-1176, US

(21) Appl. No.: 10/592,703

(22) PCT Filed: Mar. 14, 2005
(86) PCT No.: PCT/EP05/02715

§ 371 Date: Apr. 22, 2008

(30) Foreign Application Priority Data
Mar. 14, 2004 (DE) 10 2004 012 458.2

(51) Int. Cl. B32B 21/02; B27N 5/00; B27N 3/04; B30B 3/04

(52) U.S. Cl. 428/222; 428/534; 156/257; 100/176

(57) ABSTRACT

Disclosed is a three-dimensional structure (4) consisting of natural fibers in the form of matting, panels, hollow bodies, molded parts or the like, wherein the natural fibers are fibers of the hop plant, particularly the stems (1) of the hop. Hitherto, only the umbellae of hops were used, particularly for the brewing of beer, wherein the rest of the plant was removed in a variety of manners. The invention makes it possible to also use the stems (1) of the hop plant, which make up the largest part of the plant, and optionally the leaves of the hop plant, for the production of the three-dimensional structure. The stems (1) of the hops can be used for certain products, even together with metal wires adhering thereto after harvesting. The invention also relates to a method for further processing the hop plant relieved of the umbellae and to various uses of the structure.

The invention relates to a three-dimensional, natural-fiber structure in the form of matting, panels, hollow bodies, molded parts or the like.

Three-dimensional, natural-fiber structures are known e.g. as insulating material, e.g. sound-proofing material and/or thermally insulating material, formed as matting and also panels.

Thus, already in ancient times, reed was used for house construction. Reed is valued quite highly because of its good insulating ability against heat and cold. The stems, in the case of panel manufacture, are packed between parallel, zinc-coated, iron wires. These are held together by zinc-coated wire clips. The strength of panels packed in this way is sufficiently great, that they can be directly nailed beneath ceiling joists and plastered. A plaster thickness of 1 cm is sufficient. The panels are, despite large formats, very light and can, therefore, be used in many different ways. For certain uses, also other binding means, such as e.g. sisal, are possible.

Also coconut fibers arising in the course of the coconut harvest can be processed loose, or with latex, into felt material or panels. Because of its good foot-fall properties, the latex-containing grade is used frequently as flooring.

Flax insulations are manufactured from flax tow, a byproduct in the production of linen. This is treated with borax, in order to achieve the necessary fire and insect resistance. Flax insulation is available as panels, fleece, felt, loose for packing, as cord, or as shells for pipe insulation.

Also hemp, which, in the meantime can again be grown, is usable in various forms as construction material. For such purpose, above all, the so-called shives (splintered woody part of the stem) are used. However, also thick insulating fleeces and felts are known. Thus, the hemp straw or the fibers can be used for strengthening construction panels and components.

From EP 0 931 862, a method is known, in which bast fibers e.g. of flax, oil-seed flax, hemp, ramie, milkweed or hops are cut and then chemically treated to remove the lignin and pectin. After drying of the fibers, they are mechanically opened, e.g. on a carder, and then processed to a non-woven material.

Used as starting material in such case are only the bast fibers of the respective plants. The leaves, seed capsules, bark and woody core of the plants were first removed.

As indicated in “Naturfaser-Lexikon” (Natural Fiber Lexicon), Anton Schenk, Frankfurt am Main, Deutscher Fachverlag, Publisher, 2000, Page 109, fibers from the stems of the hops plant, thus hops fibers, are only used for textile purposes in times of need, as a flax substitute.

For the production of beer, great quantities of hops are used. However, for beer, only the hop umbels, or umbellae, are needed, while the remaining hop plant material is mulched as waste and composted, burned or plowed under.

On the other hand, hops farmers are having, ever more, to abandon their production of hops in favor of other plants, since, due to factors such as less beer consumption and more modern methods of production, an over-production of hops is noticeable on the world market.

An object of the invention is to provide an additional use for the entire hop plant.

This object is achieved by a structure as defined in claim 1, a method as defined in claim 9 and various uses as defined in claim 23.

According to the invention, three-dimensional, natural-fiber structures, in the form of matting, panels, hollow bodies, molded parts, or the like, are formed, wherein the natural fibers are fibers of the hop plant and are formed by its stem. While, in the past, the greatest part of the hop plants, namely the hop stems and the hop leaves, was disposed of as waste, it is now proposed to manufacture matting, panels, hollow bodies, molded parts and the like, at least from the parts not needed for the brewing of beer. Especially, for this purpose, hop stems are used in full length. They can, however, also be used in cut, shortened form and be present as such in the structure. Hop fibers belong to the longest, naturally growing fibers; they can grow to be 7 m long. Hop stems are, especially after drying, relatively stiff. For this reason, depending on the particular application, relatively stiff structures can be formed, alone by use only of the hop stems.

According to a special form of embodiment, the stems are present, cut or broken, in strip shape. This can especially be achieved by pressing the dried, or to be dried, hop stems between corrugated rollers.

When greater stiffness is desired in the structure, then the hop stems can still include the metal wire, on which they wound themselves upwards, when they were growing. In this way, even the wires can be used again, which have otherwise mostly been plowed under in the hops garden, following mulching of the hop stems.

In a special form of embodiment, the structure is a mat, or panel, bonded with a binder, to give it a solid coherence. Examples of binders are synthetic resin systems, such as epoxy resins, polyesters, polyurethanes, melamine, or phenolic, resins, or natural resins or adhesives, or mineral binders, such as cement and plaster.

For certain applications and characteristics, the hop stems and/or wires can also be pretreated, e.g. with bond promoters, primers and special preservatives.

Especially when the structure is a pressed panel, whose intended use is as a table top, the structure can additionally contain hop umbels and/or hop leaves, which are visible to an onlooker.

Preferably, the structure includes a plurality of layers, of which at least one includes bast fibers of hop stems, while another layer contains woody shives thereof. The surface of the structure can, in this way be finer, and, in the case of pressed structures, smoother, without interstices between the hop stems requiring much binder.

A special form of embodiment of the structure includes essentially areal, three-dimensionally shaped, fiber-reinforced, composite bodies, such as e.g. shell-shaped bodies, vessels, or the like.

The structure can also be, in a special form of embodiment, a braided material of hop stems.

A method for manufacturing three-dimensional structures is distinguished by the feature, that, following the harvesting of the hop plants and after removal of the hop umbels, the remaining hop plant material is used for manufacture of the three-dimensional structures.

Advantageously, for such purpose, the hop stems and, if desired, also the hop leaves and/or the umbels, are dried. This drying can especially be accelerated by pressing of the hop stems, with, particularly, pressing between two rotating rollers being a suitable way of doing this. In such case, the juice is pressed out of the stems, and the stems are pressed flat, this being especially advantageous for later manufacture of panels and molded parts.

In a special form of embodiment of the method, the hop stems and, if desired, the hop leaves and/or the hop umbels are not comminuted following harvest of the hops, but, instead, are used in grown length, respectively size, for the manufacture of the three-dimensional structures. In such case, the metal wires, about which the hop stems have wound themselves, can remain. These are thus retained in full length, whereby the structure receives additional tensile strength and stiffening.

Instead of the mulching, the hop stems are, thus, fed in full length to a further processing and, e.g., stored in a fleece-like state.

In a special method step, the hop stems are stored in a fleece-like state, wherein the hop stems extend with a multitude of different orientations.

Alternatively, the hop stems can also be placed in a fleece-like state with cross-stacking, wherein, over each layer of hop stems lying in one direction, a layer of hop stems lying transversely thereto is laid. In the case of conveyor production of the fleece-like structure, the hop stems can then be arranged in each case inclined to the conveyor direction, whereby longitudinal and transverse strength is achieved in the structure.

The fleece-like structure can be formed, also, from long, uncut hop stems and cut, short hop stems, with the short hop stems being introduced into the interstices between the long hop stems, in order to make the fleece-like structure fuller.

In another form of embodiment of the method, the hop stems are soaked with a binder, e.g. of synthetic resin or a natural glue. This soaking can be done before or after the depositing of the hop stems in the form of a fleece-like structure. The hop stems are, for such purpose, e.g. dunked into the binder, with excess binder dropping off, following the dunking. In this way, the structure achieves a better coherence, or cohesion.

The fleece-like structure of hop stems and, if desired, hop leaves and/or hop umbels, previously soaked with a binder, is, in one form of embodiment, pressed to panels. If desired, also fillers and extra binder can be added, when e.g. a smooth surface is desired for the structure.

It is also possible that, in the build-up of the structure, a layer of shives is placed on a layer of fibers, and a further layer of fibers is then advantageously used to cover the layer of shives. In this case, it is possible to achieve a smooth surface for the structure, since the fibers more easily fill the interstices between the shives.

For this embodiment, it is expedient that the bast fibers be separated from the woody shives in a separate method step.

It is, however, also possible to process the separated bast fibers further in a separate method step into a first structure, e.g. to flexible mats, and to process the woody shives in another method step into a further structure of another character, e.g. rigid panels. In this way, by making use of the different characteristics of the components, different structures can be manufactured.

It is also possible to braid the hop stems to form a braided material. Binder or the like is then not absolutely necessary.

In a special method step, the hop stems are separated, following harvest, into bast fibers and woody shives. The two components, or fractions, can them be used in different layers of the structure. The two fractions of the hop stem can, however, also be further processed, in procedures separate from one another, into two different, three-dimensional structures.

The wires, about which the hop stems wind, can, in such case, be removed; the wires can, however, also remain on the woody shives, in order to provide these with stiffening.

A structure of the invention can, depending on the particular, aforementioned method steps, be used as insulating material, construction panel, table tops, especially for beer table tops, or also as fencing, especially for snow fences.

In the following, the manufacture of a three-dimensional structure will now be briefly described, which structure can be used as a panel.

The hop umbels are separated, in known manner, from the hop stems following the harvest. The hop stems are, however, not mulched, but, instead, fed in full length between the two rollers of a roll press. In such case, not only the plant juice is pressed out of the stems, but, also, the originally circularly shaped cross section of the hop stems is pressed flat. In the course of such, the stems can break in the longitudinal direction, so that, in given instances, a plurality of long strands are obtained. These pressed hop stems are dried still further, with this possibly occurring simply over the course of storage. The dried hop stems are soaked with binder by immersion in the binder and repeatedly charged into an elongated mold having a floor and two longitudinal sidewalls. In this mold, pressure is exerted on the web of hop stems soaked with the binder, and, as required, a heat treatment is provided at the same time. The pressure can result e.g. from a pressing plunger. The pressing can be done continuously or discontinuously. The mold can have end walls, but this is not necessary, in which case an endless panel is manufactured, which is then cut into desired lengths, following curing and hardening of the binder.

Such panel-forming manufacturing-installations are known per se on the basis of various panel manufacturing methods, with reference being made e.g. to the manufacture of fiber panels or to the manufacture of particle board.

The invention will now be explained on the basis of the appended drawing, the figures of which show as follows:

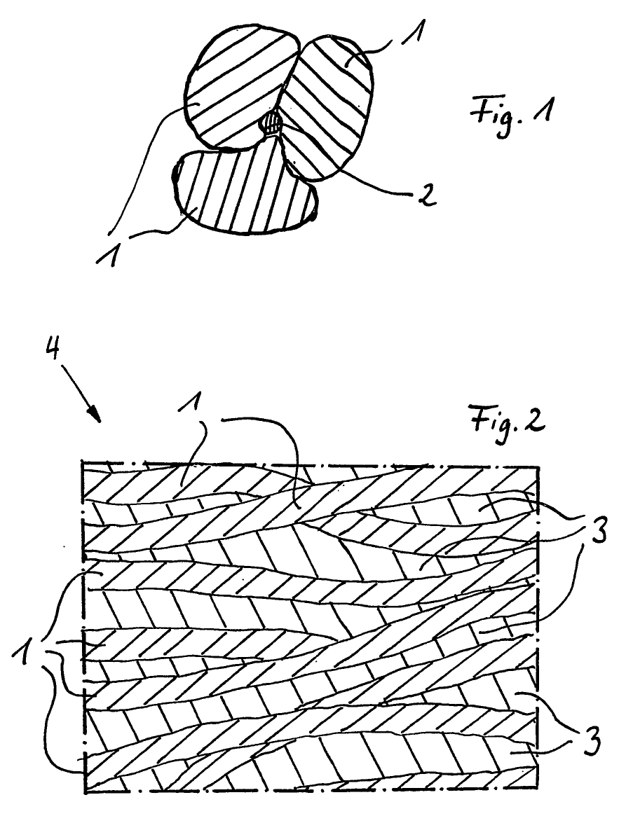

FIG. 1 a section through three hop stems wound in growth about a wire; and

FIG. 2 a portion of a cross section through a pressed panel made from hop stems.

Since hop plants grow very high and long, the hop stems 1 are guided upwards on vertically oriented wires 2. In such case, as a rule, three stems 1, or vines, grow about one guide wire 2. During harvest, the part of the hop plant above the root is harvested, along with the guide wire. Until now, however, only the umbels of the plants have been used, and it has been the practice to mulch the rest of the harvested plants and then either burn the mulch or place it on the field and plow it under.

The hop stems 1 shown in cross section in FIG. 1 are, according to the invention, (if desired, with the guide wire 2) directed to another use.

FIG. 2 shows a portion of a cross section of a panel 4 made from hop stems 1, wherein the hop stems 1 are bonded together by means of binder 3 located between the hop stems 1 and filling the interstices between the hop stems 1. Plates 4 are obtained by pressing the dried hop stems 1, soaked with binder 3, in a press under high pressure and elevated temperature, from which processing plates 4 result. Processing of this type is used, per se, by those skilled in the art for the manufacture of fiber-reinforced panels.

1-23. (canceled)

24. Three-dimensional structure comprised of natural fibers and formed as matting, panels, hollow bodies, molded parts, or the like, characterized in that the natural fibers are fibers of hop plants and are formed by dried stems of the hop plants, which are present in the structure as stems.

25. Structure as claimed in claim 24, characterized in that the stems are still together with clinging metal wires after harvesting.

26. Structure as claimed in claim 24, characterized in that the stems are present as cut or broken strips.

27. Structure as claimed in claim 24, characterized in that the structure is a mat or, preferably, a pressed panel of hop stems bonded with a binder.

28. Structure as claimed in claim 27, characterized in that the structure additionally contains hop leaves and/or hop umbels and is, preferably, a table top.

29. Structure as claimed in claim 24, characterized in that the structure has a plurality of layers, of which at least one layer comprises hop-stem fibers, while another layer contains woody, hop-stem shives.

30. Structure as claimed in claim 24, characterized in that the structure is an areal, three-dimensionally shaped, fiber-reinforced, composite body.

31. Structure as claimed in claim 24, characterized in that the structure is a braided material of hop stems.

32. Method for manufacturing a three-dimensional, natural fibers comprising structure in form of mattings, panels, hollow bodies, molded parts, or the like, wherein as the natural fibers of hop plants are used and are formed by dried stems of the hop plants, which are present in the structure as stems, characterized in that, following harvest of the hop plants and following removal of hop umbels therefrom, remaining hop plant material, at least the hop stems, are used for manufacture of the three-dimensional structure.

33. Method as claimed in claim 32, characterized in that the hop stems, especially also for accelerating drying, are pressed, preferably between two rotating rollers.

34. Method as claimed in claim 32, characterized in that the hop stems, especially also for accelerating drying, are pressed, preferably between two rotating rollers and the hop stems are cut or split into strips, preferably between corrugated rollers.

35. Method as claimed in claim 32, characterized in that the hop stems and, if desired, the hop leaves and/or hop umbels are not comminuted following harvest of the hops and are used in grown length, respectively size.

36. Method as claimed in claim 32, characterized in that, following harvest of the hop stems, bast fibers are separated from woody shives.

37. Method as claimed in claim 32, characterized in that metal wires remain on the hop stems during harvest.

38. Method as claimed in claim 32, characterized in that the hop stems are stored in a fleece-like structure wherein the hop stems extend with a multitude of different orientations.

39. Method as claimed in claim 38, characterized in that the fleece-like structure is formed of long, uncut, hop stems and cut, short, hop stems.

40. Method as claimed in claim 32, characterized in that the hop stems are soaked with a binder, e.g. of synthetic resin or natural glue, and this soaking is done before or after the storing of the hop stems in a fleece-like structure.

41. Method as claimed in claim 32, characterized in that the fleece-like structure of hop stems and, if desired, hop leaves and/or hop umbels, previously soaked with a binder, is pressed to panels or molded parts.

42. Method as claimed in claim 41, characterized in that, in a build-up of the structure, a layer of shives is laid on a layer of fibers and the layer of shives is advantageously covered by a further layer of fibers.

43. Method as claimed in claim 36, characterized in that the bast fibers are further processed in a separate method step to a first structure, e.g. flexible mats, and the woody shives are processed in another method step to a further structure of another type, e.g. rigid panels.
